(19) United States
(12) Patent Application Publication
(10) Pub. No.: US 2012/0186958 A1
(43) Pub. Date: Jul. 26, 2012

(54) BUTTON ASSEMBLY AND ELECTRONIC DEVICE USING THE SAME

(75) Inventor: WEN-YAN YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/106,809

(22) Filed: May 12, 2011

(30) Foreign Application Priority Data
Jan. 21, 2011 (CN) 201110024373.9

(51) Int. Cl. H01H 9/18

(52) U.S. Cl. 200/314; 200/308

(57) ABSTRACT

The present disclosure provides a button assembly used in an electronic device. The button assembly includes a base, a switch arranged on the base and a button. A raised logo is arranged on the switch. The button is movably arranged on the switch, and a through hole is defined on the button to receive the raised logo. An electronic device using the button assembly is also provided.

### BACKGROUND

1. Technical Field

The present disclosure relates to button assemblies and electronic devices using the button assembly.

2. Description of Related Art

A button of an electronic device such as a display include a symbol that represents a specific function. One such symbol can be seen on a power button of an LCD display. However, the symbol tends to wear off after a long time of use.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is an isometric view of an electronic device in accordance with an exemplary embodiment.

FIG. 2 is an isometric view of a button assembly used in the electronic device of FIG. 1.

FIG. 3 is an isometric, exploded view of the button assembly of FIG. 2.

### DETAILED DESCRIPTION

Embodiments of the present disclosure will now be described in detail below, with reference to the accompanying drawings.

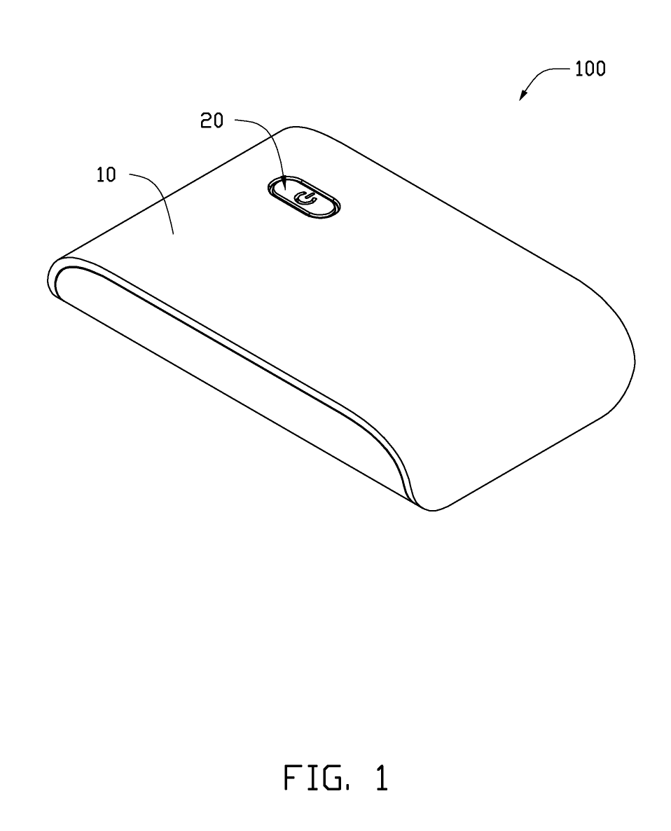

Referring to FIG. 1, an electronic device 100 includes a main body 10 and at least one button assembly 20 mounted on the main body 10. An operation is performed when the button assembly 20 is depressed. For example, if the button 20 is a power button, powering on or off the electronic device 100 is performed when the button 20 is depressed. In this embodiment, the electronic device 100 is a computer host. In another embodiment, the electronic device 100 may be a display.

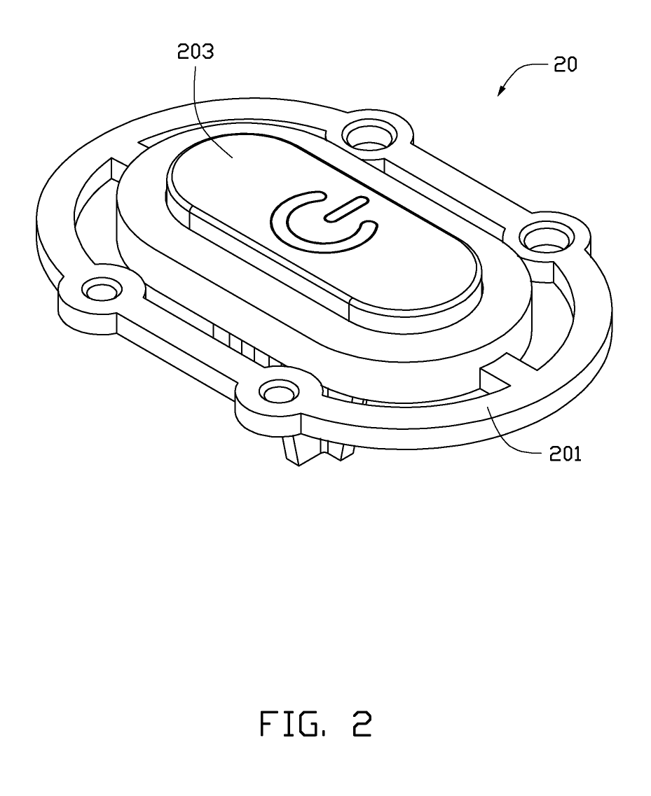

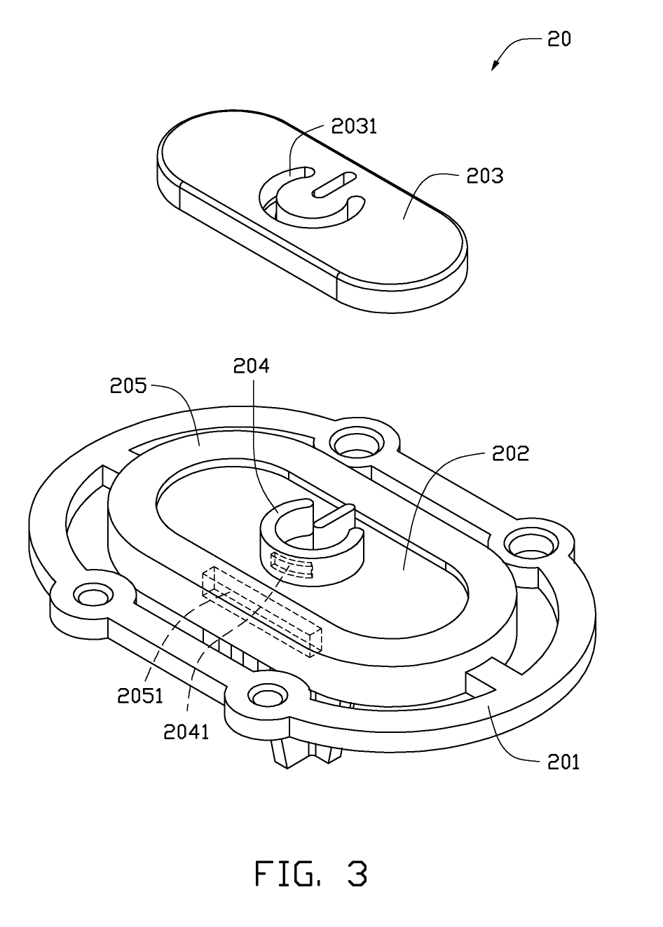

Referring to FIGS. 2-3, the button assembly 20 includes a base 201, a switch 202 mounted on the base 201, and a button 203 arranged on the switch 202. A raised logo 204 is set on the switch 202. A through hole 2031 matching with the logo 204 is set on the button 203 to receive the raised logo 204. When the button 203 is depressed, the switch 202 is actuated and sends a signal to a processing unit (not shown) of the electronic device 100. In this embodiment, the button 203 can be affixed on the switch 202 with glue when the raised logo 204 is received in the through hole 2031. The raised logo 204 and the switch 202 are integrally formed.

In this embodiment, the switch 202 is a power switch, and the raised logo 204 is a power logo. When the button 203 is depressed, the electronic device 100 is powered on or off.

In this embodiment, the raised logo 204 is made of transparent material. A first light source 2041 is arranged in the raised logo 204 to illuminate the raised logo 204 when the electronic device 100 is powered on. The button assembly 20 further includes a loop 205 arranged on the base 201 and around the button 203. The loop 205 is made of transparent material. A second light source 2051 is arranged in the loop 205 to illuminate the loop 205 to prompt the user where the button 203 is arranged.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A button assembly comprising:
a base;
a switch arranged on the base and comprising a raised logo arranged thereon; and
a button movably arranged on the switch, wherein a through hole is defined on the button to receive the raised logo.

2. The button assembly as described in claim 1, wherein the raised logo and the switch are integrally formed.

3. The button assembly as described in claim 1, wherein the raised logo is made of transparent material and a first light source is arranged in the raised logo to illuminate the logo.

4. The button assembly as described in claim 1 further comprising a loop arranged on the base and around the button, wherein the loop is made of transparent material, and a second light source is arranged in the loop to illuminate the loop.

5. The button assembly as described in claim 1, wherein the button is affixed on the switch with glue.

6. An electronic device comprising:
a main body; and
at least one button assembly comprising:
a base;
a switch arranged on the base and comprising a raised logo arranged thereon; and
a button arranged on the switch defining a through hole to receive the raised logo.

7. The electronic device as described in claim 6, wherein the raised logo and the switch are integrally formed.

8. The electronic device as described in claim 6, wherein the raised logo is made of transparent material and a first light source is arranged in the raised logo to illuminate the logo.

9. The electronic device as described in claim 6, wherein the button assembly further comprises a loop arranged on the base and around the button, the loop is made of transparent material, and a second light source is arranged in the loop to illuminate the loop.

10. The electronic device as described in claim 6, wherein the button is affixed on the switch with glue.
